(19) United States
(12) Patent Application Publication
(10) Pub. No.: US 2020/0001914 A1
(43) Pub. Date: Jan. 2, 2020

(54) TEST METHOD AND METRICS TO EVALUATE QUALITY OF ROAD FEEDBACK TO DRIVER IN A STEER-BY-WIRE SYSTEM

(71) Applicant: GM Global Technology Operations LLC, Detroit, MI (US)

(72) Inventors: Bo Yu, Novi, MI (US); Ibrahim A. Badiru, Novi, MI (US); Steven Aiuto, Commerce Township, MI (US); Gabriel de Paula Eduardo, Brighton, MI (US)

(21) Appl. No.: 16/020,389

(22) Filed: Jun. 27, 2018

(51) Int. Cl. B62D 6/00; B62D 5/00

(52) U.S. Cl. CPC B62D 6/008; B62D 5/006

(57) ABSTRACT

A method to evaluate a quality of road feedback to a driver in a steer-by-wire system includes setting a test bench by grounding a steering system steering wheel using a physical 6^{th} order impedance constraint; preloading the steering system with data defining a steering wheel angle and a vehicle speed; applying tie rod load signals to the steering system and recording signals representing each of a tie rod load, a steering wheel torque and a steering wheel acceleration. In parallel: applying first a fast Fourier transform algorithm to the recorded signals to calculate each of a gain, a phase and a coherence response from the tie rod load to the steering wheel torque; applying second a fast Fourier transform algorithm to the recorded signals to calculate a power spectral density of the steering wheel torque versus frequency; and applying frequency weighting functions to the gain and power spectral density functions.

### INTRODUCTION

The present disclosure relates to automobile vehicle steer-by-wire systems including providing torque feedback to the driver of a vehicle having a steer-by-wire system.

Automobile vehicle drivers use high frequency torque vibrations received through a steering wheel of the vehicle to obtain information about the road surface. Automobile vehicle steer-by-wire systems have no mechanical connection between a steering wheel operated by the driver and the road surface. Any feedback from the road surface to the driver through the steering wheel must therefore be electronically synthesized and recreated using a steering wheel torque actuator. This is a difficult task especially for hi-frequency “dynamic” feedback loads.

Thus, while current automobile vehicle steer-by-wire systems achieve their intended purpose, there is a need for new and improved test methods and metrics to objectively evaluate dynamic road feedback performance for automobile vehicle steer-by-wire systems.

### SUMMARY

According to several aspects, a method to evaluate a quality of road feedback to a driver in a steer-by-wire system includes: fixing a torque feed feedback actuator and a steering rack of a steer-by-wire feedback system on a test bench; synthesizing road input waveform data equating to each of a rough road, a coarse road, and a synthesized load from an exemplary single high input defining a pot-hole impact; and generating output signals from a set of waveform inputs equating to the synthesized road input waveform data for a steering wheel torque and a steering wheel acceleration.

In another aspect of the present disclosure, the method further includes recording the output signals; and applying a first fast Fourier transform algorithm to the recorded signals.

In another aspect of the present disclosure, the method further includes calculating a gain response with a weighting function over predetermined frequency bands.

In another aspect of the present disclosure, the method further includes calculating a linearity of a phase response within the predetermined frequency bands.

In another aspect of the present disclosure, the method further includes: in a first functional analysis step, a fast Fourier transform algorithm computes a discrete Fourier transform of each of the output signals to sample each signal over a period of time and divide each signal into frequency components to calculate each of a gain, a phase, and a coherence response from the road input waveform data to the steering wheel torque; in a second functional analysis step a second fast Fourier transform algorithm computes a power spectral density of the steering wheel torque defining a spectral energy distribution per unit frequency; and in a third functional analysis step conducted in parallel with the first and the second functional analyses steps frequency weighted functions are applied to the steering wheel acceleration.

In another aspect of the present disclosure, the road input waveform data equates to the rough road defines a multi-sine wave having a 100 Newton peak-to-peak amplitude and a frequency ranging between approximately 2 to 30 Hz.

In another aspect of the present disclosure, the road input waveform data equates to the coarse road defines a multi-sine wave having a 400 Newton peak-to-peak amplitude and a frequency range of interest for example between approximately 2 to 30 Hz.

In another aspect of the present disclosure, the road input waveform data equates to a high impact suspension load for example represented by a multi-sine wave having a 10000 Newton peak-to-peak amplitude and frequencies of 10 Hz, 15 Hz and 20 Hz.

In another aspect of the present disclosure, the method further includes identifying multiple objective metrics to quantify a performance of the steer-by-wire steering system within a frequency domain for a predefined tie rod load to the steering wheel torque, including: identifying an integral of the gain response including a weighting function applied over specific frequency bands; determining a phase response using a best-fit angle to measure feedback delay, identifying a linearity of the phase response within predetermined frequency bands; and calculating a coherence between the tie rod load and the steering wheel torque.

In another aspect of the present disclosure, the method further includes identifying multiple objective metrics to quantify a performance of the steer-by-wire steering system within a time domain for the steering wheel torque and the steering wheel acceleration, including: determining each of a power spectral density of the steering wheel torque, and an integral of the power spectral density with a weighting function over specific frequency bands to correlate a power of the steering wheel torque signals over specific frequency bands; and calculating a root-mean-square acceleration value of a frequency-weighted steering wheel acceleration.

In another aspect of the present disclosure, a method to evaluate a quality of road feedback to a driver in a steer-by-wire system includes: preparing a test bench by grounding a steering wheel of a steering system using a linear 6^{th} order impedance model; preloading the steering system with data defining a steering wheel angle and a vehicle speed; applying tie rod load signals to the steering system and recording output signals representing each of a tie rod load, a steering wheel torque and a steering wheel acceleration; and applying a first fast Fourier transform algorithm to the recorded signals to calculate each of a gain response with a weighing function over predetermined frequency bands and a linearity of a phase response within the predetermined frequency bands.

In another aspect of the present disclosure, the method further includes applying the first fast Fourier transform algorithm to the recorded signals to calculate a coherence response from the tie rod load to the steering wheel torque.

In another aspect of the present disclosure, the method further includes in parallel: applying a second fast Fourier transform algorithm to the recorded signals to calculate a power spectral density of the steering wheel torque; and applying a frequency weighted function to the steering wheel acceleration.

In another aspect of the present disclosure, the method further includes: applying a second frequency weighted function to each of the gain response, the phase response and the coherence response; calculating an integral of a gain response having the second frequency weighted functions; and calculating a linearity of the phase response.

In another aspect of the present disclosure, the method further includes: applying a frequency weighted function to the power spectral density of the steering wheel torque; and calculating an integral of the power spectral density of the steering wheel torque having the second frequency weighted function.

In another aspect of the present disclosure, the method further includes: applying a frequency weighted function to the steering wheel acceleration; and calculating a root-mean-square acceleration value of the steering wheel acceleration having the second frequency weighted function.

In another aspect of the present disclosure, the method further includes saving each of the integral of the gain response, the linearity of the phase response, the integral of the power spectral density of the steering wheel torque, and the root-mean-square acceleration value of the steering wheel acceleration as tactile feedback metrics in a data table.

In another aspect of the present disclosure, a method to evaluate a quality of road feedback to a driver in a steer-by-wire system includes: setting a test bench by grounding a steering wheel of a steering system using a linear 6^{th} order impedance; preloading the steering system with data defining a steering wheel angle and a vehicle speed; applying tie rod load signals to the steering system and recording signals representing each of a tie rod load, a steering wheel torque and a steering wheel acceleration; and in parallel: applying a first fast Fourier transform algorithm to the recorded signals to calculate each of a gain, a phase and a coherence response from the tie rod load to the steering wheel torque; and applying a second fast Fourier transform algorithm to the recorded signals to calculate a power spectral density of the steering wheel torque; and applying a frequency weighted function to the steering wheel acceleration.

In another aspect of the present disclosure, the method further includes applying second frequency weighted functions to each of the gain, the phase, and the coherence response.

In another aspect of the present disclosure, the method further includes calculating and storing each of: an integral of a gain response and a linearity of a phase response; an integral of the power spectral density of the steering wheel torque; and a root-mean-square acceleration value of the steering wheel acceleration.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is an exploded view of a steer-by-wire feedback system according to an exemplary embodiment;

FIG. 2 is a flow diagram of the system of FIG. 1;

FIG. 3 is a top plan view of an exemplary rough road surface;

FIG. 4 is a top plan view of an exemplary coarse road surface; and

FIG. 5 is an exemplary view of an exemplary high impact pothole surface;

FIG. 6 is a side elevational view of an exemplary human input used to create an impedance model of the present disclosure;

FIG. 7 is a flow diagram of the steer-by-wire feedback system of FIG. 1;

FIG. 8 is a graph comparing a gain response to a frequency and presents a curve for an exemplary integral of the gain response having a human weighting function applied over specific frequency bands;

FIG. 9 is a graph comparing a phase response to a frequency and presents a curve of an exemplary linearity of the phase response within predefined frequency bands; and

FIG. 10 is a graph comparing a power spectrum density to a frequency and presents a curve for an exemplary integral of the power spectrum density of the steering wheel torque with a weighting function over specific frequency bands.

### DETAILED DESCRIPTION

The following description is merely exemplary in nature and is not intended to limit the present disclosure, application, or uses.

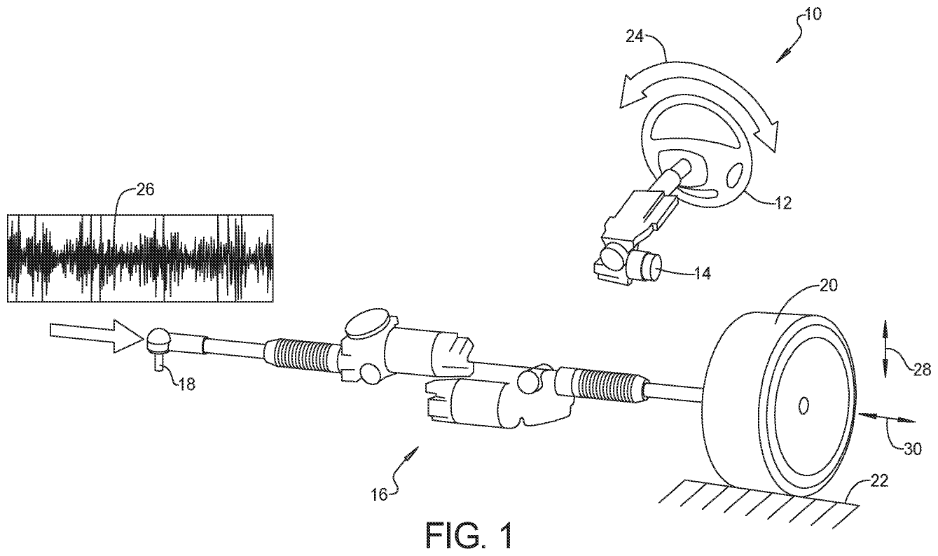

Referring to FIG. 1, a steer-by-wire feedback system 10 includes a steering wheel 12 which when rotated by a vehicle driver, shown in reference to FIG. 6, actuates a sensor inside an electric motor defining a torque feedback actuator 14 which generates electrical signals representing steering wheel angular rotation to a vehicle steering system or steering rack 16. The steering rack 16 is connected using at least one tie rod 18 to at least one steerable wheel 20 which directly contacts a road surface 22. In the steer-by-wire feedback system 10 there is no mechanical connection between the steering wheel 12 and the steering rack 16. There is therefore no direct mechanical connection to the steering wheel 12 of a steering wheel torque 24 that is generated by an input road load 26 from the wheel 20 which is defined as a combination of a vertical force 28 and a lateral force 30 acting on the wheel 20 as the wheel 20 responds to the road surface 22. The steer-by-wire feedback system 10 therefore synthesizes the steering wheel torque 24 to improve the driving experience.

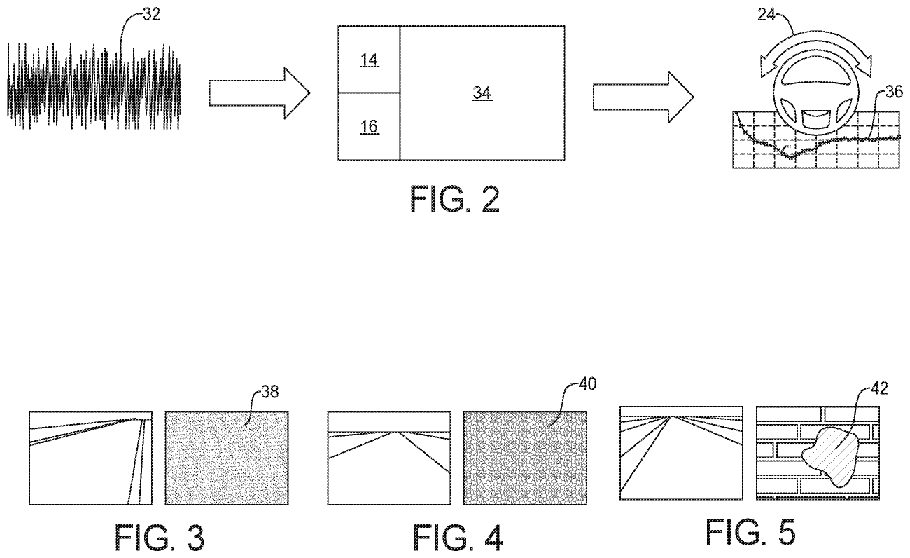

Referring to FIG. 2 and again to FIG. 1, in order to confirm if any steer-by-wire configuration to be tested meets the minimum standards of the steer-by-wire feedback system 10 of the present disclosure, and to characterize the relationship between typical road inputs to driver feedback torque, a set of tie rod load signals in the form of signal or waveform inputs 32 are used as a substitute for the real-road conditions defined by the input road load 26. The torque feedback actuator 14 and the steering rack 16 of the steer-by-wire feedback system 10 are fixed on a test bench 34 to confirm if the desired feedback of the steering wheel torque 24 is reproduced. An output signal 36 from the set of waveform inputs 32 is generated based on synthesized road input waveform data equating to each of a rough road, a coarse road such as coarse asphalt or cobblestone that generates higher vertical forces 28 and lateral forces 30 on the wheel 20 than from the rough road, and a synthesized load from an exemplary single high input such as from a pot-hole impact.

Referring to FIG. 3 and again to FIGS. 1 through 2, to synthesize a rough road 38 input to the set of waveform inputs 32, a waveform #1 is input. According to several aspects, the waveform #1 defines a multi-sine wave having for example a 100 Newton peak-to-peak amplitude and a frequency ranging between approximately 2 to 30 Hz.

Referring to FIG. 4 and again to FIGS. 1 through 3, to synthesize a coarse road 40 such as coarse asphalt or cobblestone input to the set of waveform inputs 32, a waveform #2 is input. According to several aspects, the waveform #2 for example defines a multi-sine wave having a 400 Newton peak-to-peak amplitude and a frequency ranging between approximately 2 to 30 Hz.

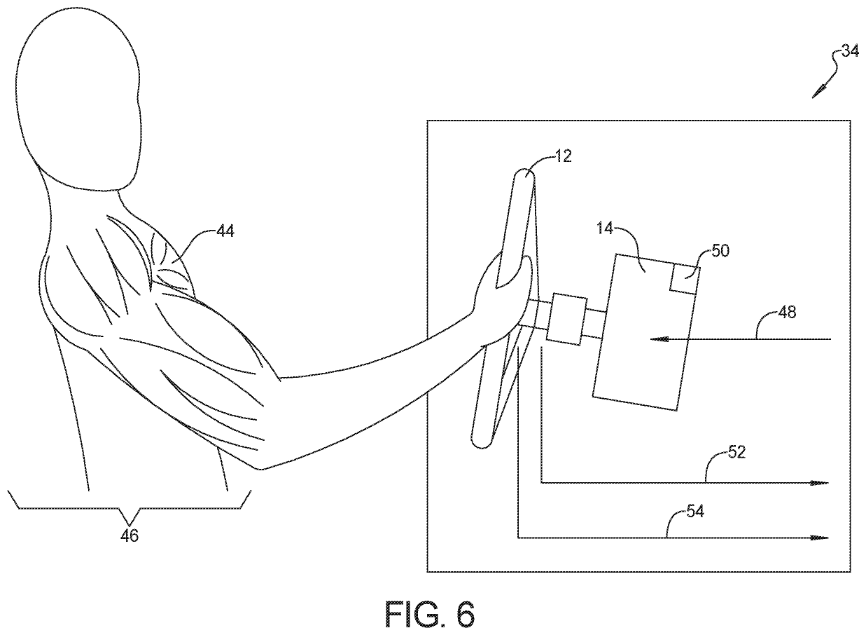

Referring to FIG. 5 and again to FIGS. 1 through 4, to synthesize a high impact load such as generated from a pot-hole 42 into the set of waveform inputs 32, a waveform #3 is input. According to several aspects, the waveform #3 for example defines a multi-sine wave having a 10000 Newton peak-to-peak amplitude and frequencies of 10 Hz, 15 Hz and 20 Hz.

Referring to FIG. 6 and again to FIGS. 1 and 2, to perform confirmation testing, the test bench 34 is set up to accurately mimic human-machine system dynamics. To accomplish this, the steering wheel 12 is constrained to ground using impedance models with variable parameters for different grip force, rotational holding torque, and hand holding position. The impedance models are based on input forces mimicking a driver 44 that were developed from human measurements taken from an area 46 defining the shoulder and arm muscles. A torque demand 48 is determined using one or more sensors 50, and each of a measured steering wheel torque 52 and a measured steering wheel angle 54 are output.

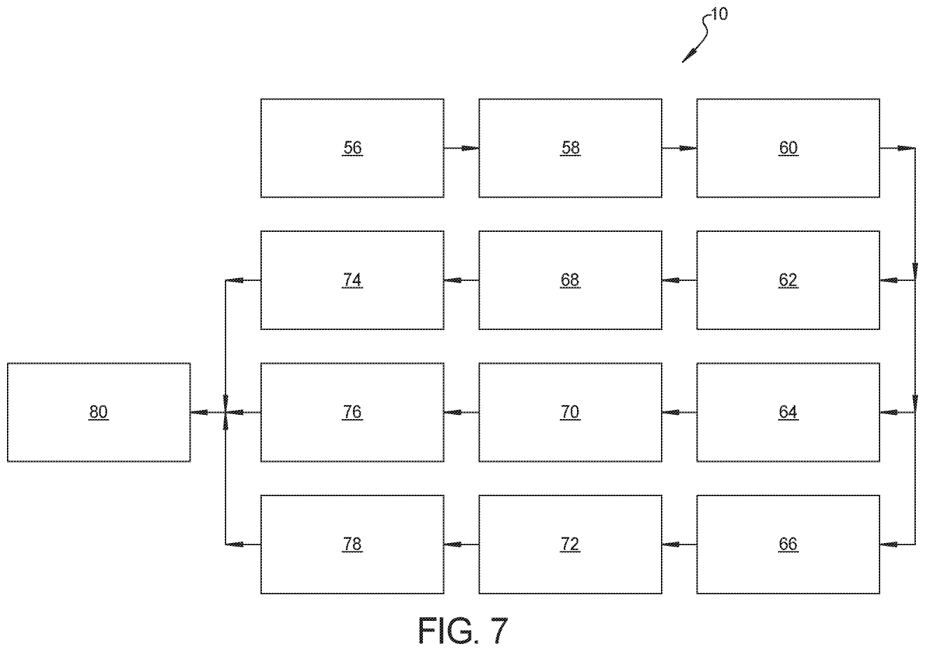

Referring to FIG. 7 and again to FIGS. 1, 2 and 6, a process and analyses flow chart provides the various flow steps to apply the steer-by-wire feedback system 10 of the present disclosure. In an initial step 56, the steering wheel 12 is grounded to the test bench 34 using an impedance constraint. In a second step 58, a preload is applied to the steering system or steering rack 16 to mimic an operating condition of a predetermined steering wheel angle and a vehicle speed. In a third step 60, the tie rod load signals in the form of waveform inputs 32 are applied, and each of a tie rod load, a steering wheel torque, and a steering wheel acceleration are recorded.

The output from the third step 60 is fed to multiple frequency analyses functions which are conducted in parallel. In a first functional analysis step 62, a fast Fourier transform (FFT) algorithm computes a discrete Fourier transform (DFT) of the output signals from the third step 60 to sample each signal over a period of time and divide the signal it into its frequency components to calculate each of a gain, a phase, and a coherence response from the tie rod load signals to steering wheel torque. In a second functional analysis step 64 a second fast Fourier transform (FFT) algorithm computes a power spectral density of the steering wheel torque defining a spectral energy distribution found per unit time. In a third functional analysis step 66, also conducted in parallel with the first and the second functional analyses steps 62, 64, frequency weighted functions are applied to the steering wheel acceleration.

Frequency weighted functions are then individually applied to each of the output from the first functional analysis step 62 in a first application step 68, to the output from the second functional analysis step 64 in a second application step 70, and to the output from the third functional analysis step 66 in a third application step 72. In a first calculation step 74, an integral of a gain response and a linearity of a phase response are determined from the output of the first application step 68. In a second calculation step 76, an integral of the power spectral density of the steering wheel torque is determined from the output of the second application step 70. In a third calculation step 78, a root-mean-square acceleration value of the steering wheel acceleration is determined from the output of the third application step 72. In a final storing step 80, the output from each of the first calculation step 74, the second calculation step 76 and the third calculation step 78 are stored as tactile feedback metrics in a data table for analyses and comparison to a predetermined set of metric data for the steer-by-wire feedback system 10 of the present disclosure.

Multiple objective metrics are provided to quantify the performance of a tested steer-by-wire steering system using the steer-by-wire feedback system 10 of the present disclosure within the frequency domain for the tie rod load to steering wheel torque. These include a gain response which can include a gain response at discrete frequencies, and an integral of the gain response having a human weighting function applied over specific frequency bands. The objective metrics also include a phase response determined using a best-fit angle to measure feedback delay, and a determination of a linearity of the phase response within frequency bands of specific interest. Phase linearity provides an indicator of a distortion between input and output signals. Zero phase distortion correlates to a constant time delay for all frequencies, providing a linear relationship between frequency in Hz and phase response in degrees. The objective metrics further include determination of a coherence between the tie rod load and the steering wheel torque.

Referring to FIG. 8, a graph 82 comparing a gain response (Nm/N) 84 to a frequency (Hz) 86 presents a curve 88 for an exemplary integral of the gain response having a human weighting function applied over specific frequency bands. The curve 88 is a sample of multi-sine bench test results.

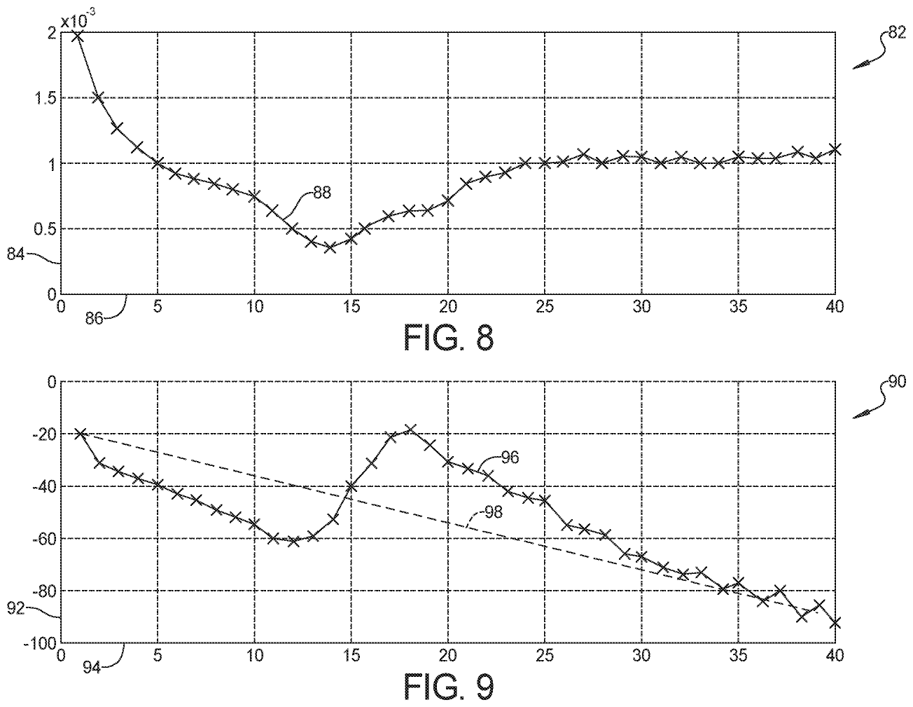

Referring to FIG. 9, a graph comparing a phase response (degrees) 92 to a frequency (Hz) 94 presents a curve 96 of an exemplary phase response curve within frequency bands of interest. The curve 96 is plotted in comparison to a desired or linear phase response curve 98. The curve 96 presents data to determine how accurately the tested steer-by-wire system reproduces the desired phase response.

Multiple objective metrics are also provided to quantify the performance of a tested steer-by-wire steering system using the steer-by-wire feedback system 10 of the present disclosure within the time domain for the steering wheel torque and the steering wheel acceleration. The multiple objective metrics include for the steering wheel torque determining a power spectral density of the steering wheel torque, and an integral of the power spectral density with a weighting function over specific frequency bands to correlate a power of the steering wheel torque signals over specific frequency bands. The multiple objective metrics also include for the acceleration of the steering wheel determining a root-mean-square acceleration value of a frequency-weighted steering wheel acceleration. The frequency-weighted steering wheel acceleration functions also consider the human perception level of rotational hand-arm vibration to different frequencies.

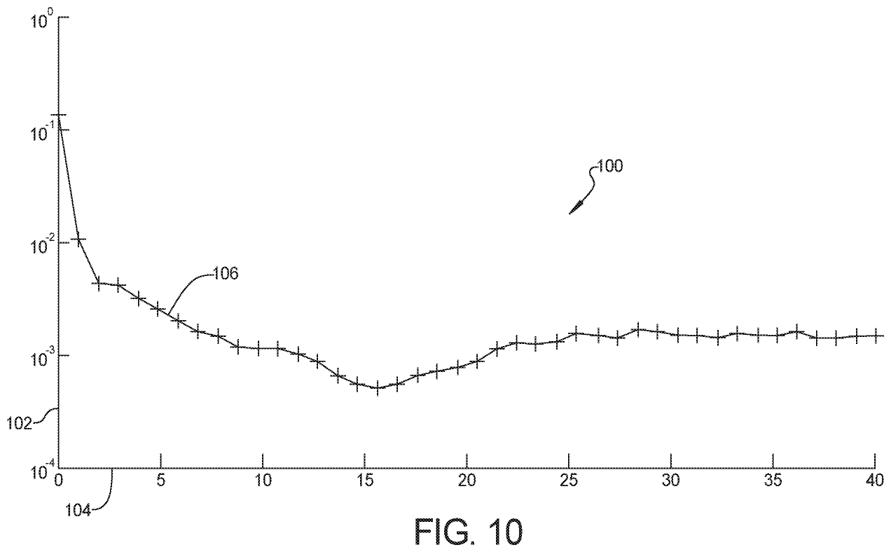

Referring to FIG. 10, a graph 100 comparing a power spectrum density (Nm²/Hz) 102 to a frequency (Hz) 104 presents a curve 106 for an exemplary integral of the power spectrum density of the steering wheel torque with a weighting function over specific frequency bands. The curve 106 is a sample of multi-sine bench test results.

The steer-by-wire feedback system 10 of the present disclosure offers several advantages. These include the use of mechanical impedance models of the human arm to mimic a drivers' biomechanical properties. Test methods correlate with real world data and are used to evaluate dynamic road feedback performance. Objective metrics are provided to quantify the performance of the steer-by-wire system. The steer-by-wire feedback system 10 of the present disclosure also provides drivers the choice to receive appropriate torque vibration feedback and thereby to receive dynamic road feedback performance.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method to evaluate a quality of road feedback to a driver in a steer-by-wire system, comprising:
fixing a torque feedback actuator and a steering rack of a steer-by-wire feedback system on a test bench;
synthesizing road input waveform data equating to each of a rough road, a coarse road, and a synthesized load from an exemplary single high input defining a pot-hole impact; and
generating output signals from a set of waveform inputs equating to the synthesized road input waveform data for a steering wheel torque and a steering wheel acceleration.

2. The method to evaluate a quality of road feedback to a driver in a steer-by-wire system of claim 1, further including:
recording the output signals; and
applying a first fast Fourier transform algorithm to the recorded signals.

3. The method to evaluate a quality of road feedback to a driver in a steer-by-wire system of claim 2, further including calculating a gain response with a weighting function over predetermined frequency bands.

4. The method to evaluate a quality of road feedback to a driver in a steer-by-wire system of claim 3, further including calculating a linearity of a phase response versus frequency within the predetermined frequency bands.

5. The method to evaluate a quality of road feedback to a driver in a steer-by-wire system of claim 1, wherein:
in a first functional analysis step, a fast Fourier transform algorithm computes a discrete Fourier transform of each of the output signals to sample each of the signals over a period of time and divide each of the signals into frequency components to calculate each of a gain, a phase, and a coherence response from the road input waveform data to the steering wheel torque;
in a second functional analysis step a second fast Fourier transform algorithm computes a power spectral density of the steering wheel torque defining a spectral energy distribution per unit frequency; and
in a third functional analysis step conducted in parallel with the first and the second functional analyses steps frequency weighted functions are applied to the steering wheel acceleration.

6. The method to evaluate a quality of road feedback to a driver in a steer-by-wire system of claim 1, wherein the road input waveform data equating to the coarse road defines a multi-sine wave having a predetermined amplitude, for example 100 Newton peak-to-peak amplitude and a frequency ranging between approximately 2 to 30 Hz.

7. The method to evaluate a quality of road feedback to a driver in a steer-by-wire system of claim 6, wherein the road input waveform data equating to the rough road defines a multi-sine wave having a predetermined amplitude, for example 400 Newton peak-to-peak amplitude and a frequency ranging between approximately 2 to 30 Hz.

8. The method to evaluate a quality of road feedback to a driver in a steer-by-wire system of claim 7, wherein the road input waveform data equating to a high suspension load input defines a multi-sine wave having a predetermined amplitude, for example 10000 Newton peak-to-peak amplitude and frequencies of 10 Hz, 15 Hz and 20 Hz.

9. The method to evaluate a quality of road feedback to a driver in a steer-by-wire system of claim 1, further including identifying multiple objective metrics to quantify a performance of the steer-by-wire steering system within a frequency domain for a predefined tie rod load to the steering wheel torque, including:
identifying an integral of the gain response including a weighting function applied over specific frequency bands;
determining a phase response linearity using linear regression correlation of a best-fit angle to measure feedback delay;
identifying a linearity of the phase response within predetermined frequency bands; and
calculating a coherence between the tie rod load and the steering wheel torque.

10. The method to evaluate a quality of road feedback to a driver in a steer-by-wire system of claim 1, further including identifying multiple objective metrics to quantify a performance of the steer-by-wire steering system within a time domain for the steering wheel torque and the steering wheel acceleration, including:
determining each of a power spectral density of the steering wheel torque, and an integral of the power spectral density with a weighting function over specific frequency bands to correlate a power of the steering wheel torque over specific frequency bands; and
calculating a root-mean-square acceleration value of a frequency-weighted steering wheel acceleration.

11. A method to evaluate a quality of road feedback to a driver in a steer-by-wire system, comprising:
preparing a test bench by grounding a steering wheel of a steering system using an impedance;
preloading the steering system with data defining a steering wheel angle and a vehicle speed;
applying tie rod load signals to the steering system and recording output signals representing each of a tie rod load, a steering wheel torque and a steering wheel acceleration; and
applying a first fast Fourier transform algorithm to the recorded signals to calculate each of a gain response with a weighing function over predetermined frequency bands and a linearity of a phase response within the predetermined frequency bands.

12. The method of claim 11, further including applying the first fast Fourier transform algorithm to the recorded signals to calculate a coherence response from the tie rod load to the steering wheel torque.

13. The method of claim 12, further including in parallel:
applying a second fast Fourier transform algorithm to the recorded signals to calculate a power spectral density of the steering wheel torque; and
applying a frequency weighted function to the steering wheel acceleration.

14. The method of claim 13, further including:
applying a second frequency weighted function to each of the gain response, the phase response and the coherence response;
calculating an integral of the gain response having the second frequency weighted functions; and
calculating a linearity of the phase response.

15. The method of claim 14, further including:
applying the second frequency weighted function to the power spectral density of the steering wheel torque; and
calculating an integral of the power spectral density of the steering wheel torque having the second frequency weighted function.

16. The method of claim 15, further including:
applying the second frequency weighted function to the steering wheel acceleration; and
calculating a root-mean-square acceleration value of the steering wheel acceleration having the second frequency weighted function.

17. The method of claim 16, further including saving each of the integral of the gain response, the linearity of the phase response, the integral of the power spectral density of the steering wheel torque, and the root-mean-square acceleration value of the steering wheel acceleration as tactile feedback metrics in a data table.

18. A method to evaluate a quality of road feedback to a driver in a steer-by-wire system, comprising:
setting a test bench by grounding a steering wheel of a steering system using an impedance;
preloading the steering system with data defining a steering wheel angle and a vehicle speed;
applying tie rod load signals to the steering system and recording signals representing each of a tie rod load, a steering wheel torque and a steering wheel acceleration; and
in parallel:
applying a first fast Fourier transform algorithm to the recorded signals to calculate each of a gain, a phase and a coherence response from the tie rod load to the steering wheel torque;
applying a second fast Fourier transform algorithm to the recorded signals to calculate a power spectral density of the steering wheel torque; and
applying a frequency weighted function to the steering wheel acceleration.

19. The method to evaluate a quality of road feedback to a driver in a steer-by-wire system of claim 18, further including applying second frequency weighted functions to each of the gain, the phase, and the coherence response.

20. The method to evaluate a quality of road feedback to a driver in a steer-by-wire system of claim 19, further including calculating and storing each of:
an integral of a gain response and a linearity of a phase response;
an integral of the power spectral density of the steering wheel torque; and
a root-mean-square acceleration value of the steering wheel acceleration.
